(19) United States
(12) Patent Application Publication
(10) Pub. No.: US 2022/0253700 A1
(43) Pub. Date: Aug. 11, 2022

(54) AUDIO SIGNAL TIME SEQUENCE PROCESSING METHOD, APPARATUS AND SYSTEM BASED ON NEURAL NETWORK, AND COMPUTER-READABLE STORAGE MEDIUM

(71) Applicant: Beijing Moviebook Science and Technology Co., Ltd., Beijing (CN)

(72) Inventor: Teng SUN, Beijing (CN)

(73) Assignee: Beijing Moviebook Science and Technology Co., Ltd., Beijing (CN)

(21) Appl. No.: 17/623,608

(22) PCT Filed: Nov. 19, 2020
(86) PCT No.: PCT/CN2020/130053

§ 371 Date: Dec. 29, 2021

(30) Foreign Application Priority Data
Dec. 11, 2019 (CN) 201911262324.1

(51) Int. Cl. G06N 3/08; G10L 21/0232

(52) U.S. Cl. CPC G06N 3/08; G10L 21/0232

(57) ABSTRACT

An audio signal time sequence processing method and apparatus based on a neural network are provided. The audio signal time sequence processing method includes creating a combined network model, wherein the combined network model comprises a first network and a second network; acquiring a time-frequency graph of an audio signal; optimizing the time-frequency graph to obtain network input data; using the network input data to train the first network, and performing a feature extraction to obtain a multi-dimensional feature pattern; using the multi-dimensional feature pattern to construct a new feature vector; and inputting the new feature vector into the second network for training. The audio signal time sequence processing method solves a problem of an existing mapping transformation model based on a time sequence being unable to meet a multi-modal information application requirement.

The present application claims priority to Chinese Patent Application No. CN201911262324.1, titled “AUDIO SIGNAL TIME SEQUENCE PROCESSING METHOD, APPARATUS AND SYSTEM BASED ON NEURAL NETWORK, AND COMPUTER-READABLE STORAGE MEDIUM”, filed on Dec. 11, 2019 with the China National Intellectual Property Administration, which is incorporated herein by reference in its entirety.

### FIELD

The embodiments of the present disclosure relate to the field of voice data processing, and in particular to neural network-based method, device and system for processing an audio signal time sequence.

### BACKGROUND

Rapid development of neural networks in the field of artificial intelligence has promoted cross-fusion of information in multiple fields such as image, text, and speech, forming a kind of multimodal information. There is a correlation between co-occurrence or co-occurring single-modal information in the multi-modal information. While studying the correlation, due to a collection environment of multi-modal data and difference in data formats, a potential correlation of multi-domain information is not easy to be observed. It is necessary to design a suitable model to learn a potential and complex mapping relationship in the data.

However, in the current deep neural network model based on time sequence information, there are few mapping transformation models that map speech data time sequence to corresponding text content and voice action of a vocal cavity of a speaker, which still cannot meet the application requirement of multi-modal information in fields related to intelligent systems and artificial intelligence such as object recognition, information retrieval and human-machine dialogue.

### SUMMARY

The purpose of the embodiments of the present disclosure is to provide neural network-based method, device and system for processing an audio signal time sequence, to solve the problem that the existing time sequence-based mapping transformation model cannot meet the application requirement of multimodal information.

In order to achieve the foregoing objectives, the embodiments of the present disclosure mainly provide the following technical solutions.

In a first aspect, a neural network-based method for processing an audio signal time sequence is provided according to the an embodiment of the disclosure. The method includes: creating a combined network model including a first network and a second network; acquiring a time-frequency graph of an audio signal; optimizing the time-frequency graph to obtain network input data; training the first network by using the network input data and performing feature extraction in the first network to obtain a multi-dimensional feature graph; and forming new feature vectors based on the multi-dimensional feature graph; and inputting the new feature vectors to the second network for training.

Furthermore, after acquiring a time-frequency graph of an audio signal, the method further includes: sequentially shifting an interception window of the first network to obtain intercepted time-frequency graphs with a same length, where a length of the intercepted time-frequency graph is the same as a time window length of the second network.

Furthermore, the optimizing the time-frequency graph includes: combining the time-frequency graph, a first-order difference image of the time-frequency graph and a second-order difference image of the time-frequency graph into a piece of three-dimensional image data, and cutting the three-dimensional image data.

Furthermore, a horizontal axis, a vertical axis and a longitudinal axis of the three-dimensional image data represents a time dimension, a frequency dimension and a feature dimension respectively, and the cutting the three-dimensional image data includes: cutting off, paralleling the horizontal axis, one-third of the frequency dimension along a direction from high-frequency to low-frequency and retaining two-thirds of the frequency dimension which is low-frequency three-dimensional image data as the network input data.

Furthermore, down-sampling is performed only in a frequency dimension of the three-dimensional image data and a time sequence length of the network input data is kept in a time dimension of the three-dimensional image data, when the feature extraction is performed in the first network.

Furthermore, the forming new feature vectors includes: cutting the multi-dimensional feature graph according to a time sequence, combining feature values with a same timestamp in different dimensions to generate a new feature vector, arranging the new feature vectors according to the time sequence, and sequentially inputting the new feature vectors to the second network for training.

Furthermore, the first network includes a convolutional neural network CNN, and the second network includes a recurrent neural network RNN.

In a second aspect, a neural network-based device for processing an audio signal time sequence is provided according to an embodiment of the disclosure. The device includes a model creating unit and an audio signal optimizing unit. The model creating unit is configured to create a combined network model including a first network and a second network. The audio signal optimizing unit is configured to: acquire a time-frequency graph of an audio signal, sequentially shift an interception window of the first network to obtain intercepted time-frequency graphs with a same length, where a length of the intercepted time-frequency graph is the same as a time window length of the second network; and optimize the time-frequency graph to obtain network input data. The model creating unit is further configured to: train the first network by using the network input data and perform feature extraction in the first network to obtain a multi-dimensional feature graph; and generate new feature vectors based on the multi-dimensional feature graph, and input the new feature vectors to the second network for training.

In a third aspect, a neural network-based system for processing an audio signal time sequence is provided according to an embodiment of the disclosure. The system includes: at least one memory configured to store one or more program instructions; and at least one processor configured to execute the one or more program instructions to perform the neural network-based method for processing an audio signal time sequence.

In a fourth aspect, a computer-readable storage medium is provided according to an embodiment of the disclosure. The computer-readable storage medium includes one or more program instructions. A neural network-based system for processing an audio signal time sequence executes the one or more program instructions to perform the neural network-based method for processing an audio signal time sequence.

The technical solutions provided by the embodiments of the present disclosure have at least the following advantages. According to the embodiments of the present disclosure, a CNN+RNN combined network time sequence regression model is created to process audio information, so that output of a training network is a regression value sequence with the same length as the inputted time sequence. Optimization and noise reduction is performed on audio information by using an image cutting method, down-sampling is performed only in the frequency dimension of the three-dimensional image data and time invariance is ensured, so as to better realize mapping and transformation of speech data time sequence to corresponding text content and voice action of a vocal cavity of a speaker.

### BRIEF DESCRIPTION OF THE DRAWINGS

FIG. 1 is a step diagram of a neural network-based method for processing an audio signal time sequence according to a first embodiment of the disclosure.

FIG. 2 is a schematic structural diagram of a neural network-based device for processing an audio signal time sequence according to a second embodiment of the disclosure.

FIG. 3 is a schematic structural diagram of a neural network-based system for processing an audio signal time sequence according to a third embodiment of the disclosure.

### DETAILED DESCRIPTION

The embodiments of the present disclosure will be described below through specific embodiments, and those skilled in the art can easily understand other advantages and effects of the present disclosure from the content disclosed in this specification.

In the following description, specific details such as specific system structures, interfaces, and technologies are set forth for purposes of illustration rather than limitation, so as to provide a thorough understanding of the present disclosure. However, it should be clear to those skilled in the art that the present disclosure may be practiced in other embodiments without these specific details. In other cases, detailed descriptions of well-known systems, programs, and methods are omitted, to prevent unnecessary details from obstructing the description of the present disclosure.

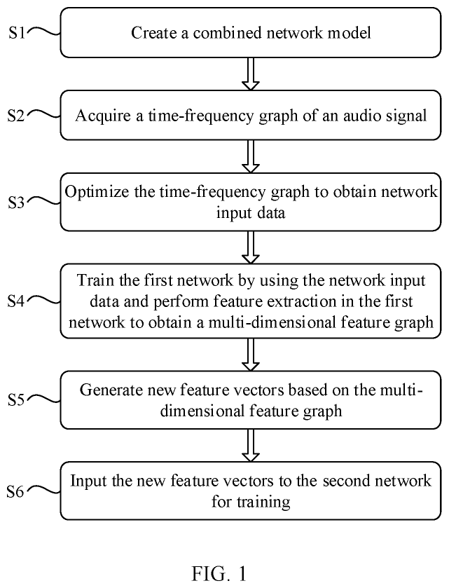

A neural network-based method for processing an audio signal time sequence is provided according to a first embodiment of the disclosure. Referring to FIG. 1, the method includes steps S1 to S6.

S1, create a combined network model.

Specifically, the combined network model includes a first network and a second network. Generally, in the conventional art, a framing process and a windowing process are performed on a voice digital signal first, and then the signal obtained after the framing process and the windowing process is converted to a spectral time sequence by Fourier transformation, to generate a time-frequency graph. Voice feature extraction is performed with an acoustic model, features such as formants and Mel cepstrum are manually extracted by using methods such as filtering frequency domain features. The extracted speech feature vectors are used for subsequent text sequence recognition. However, high-dimensional features obtained by this method are less than high-dimensional features obtained through the CNN network. In this disclosure, combining an ability of the convolutional neural network CNN to extract correlation features of local receptive fields and an ability of the recurrent neural network RNN to maintain a time sequence state, the time-frequency graph is directly used as input, and more high-dimensional features are extracted through the deep CNN network, and then the extracted features are inputted to the RNN model, to realize the extraction of audio signal features, and learn the change sequence of oral and mandibular movements that drive pronunciation. Therefore, in this embodiment, the first network is preferably a convolutional neural network CNN, and the second network is preferably a recurrent neural network RNN.

S2, acquire a time-frequency graph of an audio signal.

Specifically, collected sound data is digitally sampled into a digital audio signal. A framing process and a windowing process are performed on the digital audio signal, and then the signal obtained after the framing process and the windowing process is converted to a spectral time sequence by Fourier transformation, to generate a time-frequency graph. Mel feature conversion is performed on the time-frequency graph, to obtain features to be inputted to the CNN network.

It should be noted that, a length of a voice input signal is not fixed, a time axis length T of the obtained time-frequency graph is also variable, therefore, before the time-frequency graph is inputted into the CNN, a time-frequency graph with a time length corresponding to a time window length (t) of the RNN needs to be obtained by interception. An interception window of the CNN network is sequentially shifted, such as T(0) . . . T(0+t), T(1) . . . T(1+t), T(n) . . . T(n+t), so that the length of the time-frequency graph obtained by interception is the same as the time window length of the RNN.

S3, optimize the time-frequency graph to obtain network input data.

Specifically, in this embodiment, an image cutting method is used to reduce a noise in audio information. A first-order difference image and a second-order difference image of the time-frequency graph are calculated based on the time-frequency graph. The time-frequency graph, the first-order difference image of the time-frequency graph and the second-order difference image of the time-frequency graph form an array, which may be regarded as a piece of three-dimensional image data. A horizontal axis, a vertical axis and a longitudinal axis of the three-dimensional image data represents a time dimension, a frequency dimension and a feature dimension respectively. A low-frequency part of the three-dimensional image data shows obvious voiceprint information, and a high-frequency part of the three-dimensional image data is a large amount of random highlight noise, therefore, the high-frequency part of the three-dimensional image data is cut.

Cut off, paralleling the horizontal axis i.e., the time axis, one-third of the frequency dimension along a direction from high-frequency to low-frequency, to cut the time-frequency graph. Noise interference in the high-frequency part is removed, and only two-thirds of the frequency dimension which is low-frequency three-dimensional image data is retained as the network input data. In this way, a better noise reduction effect is obtained. Adding data of the first-order difference image and the second-order difference image of the time-frequency graph can increase the time sequence variation features.

S4, train the first network by using the network input data and perform feature extraction in the first network to obtain a multi-dimensional feature graph.

Specifically, optimized network input data obtained by cutting is inputted into the CNN network for training, and the CNN network may use a more mature network, such as ResNet, as a basic network.

It should be noted that, down-sampling is often used in signal processing, that is, a sample sequence is sampled once at intervals of several samples to obtain a new sequence. In this embodiment, the down-sampling process in the CNN network is only performed in the frequency dimension of the three-dimensional image data. A time sequence length of the network input data is kept in the time dimension of the three-dimensional image data. It can also be understood as improving the maximum pooling layer in the basic CNN, extracting a maximum pooling feature in the frequency dimension of the local receptive field, but not performing down-sampling in the time dimension, in this way, time invariance can be obtained through the maximum pooling layer and it can be ensured that the time sequence length is not compressed.

The method of extracting features with the CNN network can obtain more high-dimensional feature information than a traditional method of extracting features on the time-frequency graph through a filter.

S5, generate new feature vectors based on the multi-dimensional feature graph.

Specifically, the above-mentioned multi-dimensional feature graph is cut according to a time sequence, feature values with a same timestamp in different dimensions are combined to generate a new feature vector, the new feature vectors are arranged according to the time sequence, and the new feature vectors are sequentially inputted to the RNN network for training.

S6, input the new feature vectors to the second network for training.

Specifically, using an ability of the RNN network to maintain a time sequence state, the new feature vectors are inputted to the RNN network for training. The output of the RNN network is a regression value sequence with the same length as the inputted time sequence. The regression value may be an image, coordinates of a vocal mouth type or a text vector corresponding to the audio information according to the needs of the combined network model. It is provided a method of generating an action sequence of a part that drive pronunciation, such as oral cavity and jaw, based on speech time sequence. The RNN network of the present disclosure adopts a bidirectional LSTM model, which can provide time sequence status information about the forward direction and the backward direction.

According to the embodiments of the present disclosure, a CNN+RNN combined network time sequence regression model is created to process audio information, so that output of a training network is a regression value sequence with the same length as the inputted time sequence. Optimization and noise reduction is performed on audio information by using an image cutting method, down-sampling is performed only in the frequency dimension of the three-dimensional image data and time invariance is ensured, so as to better realize mapping and transformation of speech data time sequence to corresponding text content and voice action of a vocal cavity of a speaker.

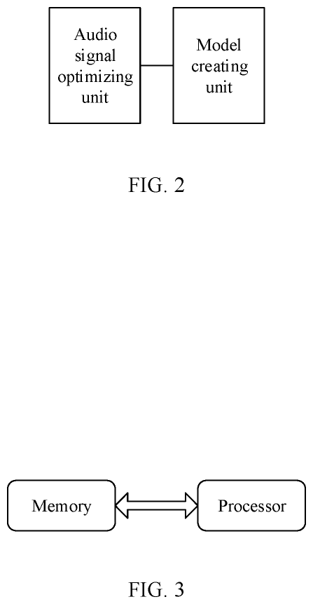

Corresponding to the foregoing embodiment, a neural network-based device for processing an audio signal time sequence is provided according to a second embodiment of the disclosure. Referring to FIG. 2, the device includes a model creating unit and an audio signal optimizing unit.

The model creating unit is configured to create a combined network model including a first network and a second network. That is, the combined network model is the above CNN+RNN combined network time sequence regression model.

The audio signal optimizing unit is configured to: acquire a time-frequency graph of an audio signal, sequentially shift an interception window of the first network to obtain intercepted time-frequency graphs with a same length, where a length of the intercepted time-frequency graph is the same as a time window length of the second network; and optimize the time-frequency graph to obtain network input data.

The audio signal optimizing unit performs digital sampling on collected sound data to obtain a digital audio signal, then performs a framing process and a windowing process on the digital audio signal, and then converts the signal obtained after the framing process and the windowing process to a spectral time sequence by Fourier transformation, to generate a time-frequency graph. This technology is an existing technology and is not described in detail here. Optimizing the time-frequency graph includes adding data of the first-order difference image and the second-order difference image of the time-frequency graph, increasing time sequence change features, and then performing cutting to retain a low-frequency image.

The model creating unit processes the audio signal time sequence with the created combined network model. The process includes: training the first network by using the network input data and performing feature extraction in the first network to obtain a multi-dimensional feature graph; and generating new feature vectors based on the multi-dimensional feature graph, and inputting the new feature vectors to the second network for training. Specific components of the device are described in detail in the above-mentioned embodiments, and are not repeated here.

According to the embodiments of the present disclosure, a CNN+RNN combined network time sequence regression model is created to process audio information, so that output of a training network is a regression value sequence with the same length as the inputted time sequence. Optimization and noise reduction is performed on audio information by using an image cutting method, down-sampling is performed only in the frequency dimension of the three-dimensional image data and time invariance is ensured, so as to better realize mapping and transformation of speech data time sequence to corresponding text content and voice action of a vocal cavity of a speaker.

Corresponding to the foregoing embodiment, a neural network-based system for processing an audio signal time sequence is provided according to a third embodiment of the disclosure. Referring to FIG. 3, the system includes: at least one memory configured to store one or more program instructions; and at least one processor configured to execute the one or more program instructions to perform the neural network-based method for processing an audio signal time sequence.

Corresponding to the foregoing embodiment, a computer-readable storage medium is provided according to a fourth embodiment of the disclosure. The computer-readable storage medium includes one or more program instructions. A neural network-based system for processing an audio signal time sequence executes the one or more program instructions to perform the neural network-based method for processing an audio signal time sequence.

A computer-readable storage medium is provided according to an embodiment of the disclosure. The computer-readable storage medium stores computer program instructions. The computer program instructions, when executed by a computer, cause the computer to perform the above method.

In the embodiments of the present disclosure, the processor may be an integrated circuit chip with signal processing capability. The processor may be a general-purpose processor, a graphic processing unit (GPU for short), a digital signal processor (DSP for short), an application specific integrated circuit (ASIC for short), and a field programmable gate array (FPGA for short) or other programmable logic devices, discrete gates or transistor logic devices, discrete hardware components.

The processor may implement or execute methods, steps and logical block diagrams disclosed in the embodiments of the present disclosure. The general-purpose processor may be a microprocessor or any conventional processor. Steps of the method disclosed in conjunction with the embodiments of the present disclosure may be performed by a hardware decoding processor or may be performed by a hardware module in combination with a software module in the decoding processor. The software module may be located in the conventional storage medium in the art, for example a random memory, a flash memory, a read only memory, a programmable read only memory, an electric erasable programmable memory, or a register. The processor reads the information in the storage medium and completes the steps of the above method in combination with its hardware.

The storage medium may be a memory, for example, may be a volatile memory or a non-volatile memory, or may include both volatile memory and non-volatile memory.

The non-volatile memory may be a read-only memory (ROM for short), a programmable ROM (PROM for short), and an erasable PROM (EPROM for short), electrically EPROM (EEPROM for short) or flash memory.

The volatile memory may be a random access memory (RAM for short), which is used as an external cache. By way of exemplary but not restrictive description, many forms of RAM are available, such as static RAM (SRAM for short), dynamic RAM (DRAM for short), and synchronous DRAM (SDRAM for short), double data rate SDRAM (DDRSDRAM for short), enhanced SDRAM (ESDRAM for short), synchlink DRAM (SLDRAM for short) and Direct Ram bus RAM (DRRAM for short).

The storage medium described in the embodiments of the present disclosure are intended to include, but are not limited to, these and any other suitable types of memories.

A person skilled in the art may realize that, in the foregoing one or more examples, the functions described in the present disclosure may be implemented by using combination of hardware and software. When the functions are implemented by software, these functions may be stored in a computer-readable medium or transmitted as one or more instructions or code in the computer-readable medium. The computer-readable medium includes a computer storage medium and a communications medium. The communications medium includes any medium that enables a computer program to be transmitted from one place to another. The storage medium may be any available medium accessible to a general or specific computer.

In the foregoing specific implementations, the objective, technical solutions, and beneficial effects of the present disclosure are further described in detail. It should be understood that the foregoing descriptions are merely specific implementations of the present disclosure, but are not intended to limit the protection scope of the present disclosure. Any modification, equivalent replacement, or improvement made based on the technical solutions of the present disclosure should fall within the protection scope of the present disclosure.

What is claimed is:

1. A neural network-based method for processing an audio signal time sequence, comprising the following steps of:
creating a combined network model comprising a first network and a second network;
acquiring a time-frequency graph of an audio signal, sequentially shifting an interception window of the first network to obtain intercepted time-frequency graphs with an identical length, wherein a length of each of the intercepted time-frequency graphs is identical to a time window length of the second network;
optimizing the intercepted time-frequency graphs to obtain optimized time-frequency graphs, combining the optimized time-frequency graphs, a first-order difference image of the optimized time-frequency graphs and a second-order difference image of the optimized time-frequency graphs into a piece of three-dimensional image data, and cutting the three-dimensional image data to obtain network input data;
training the first network by using the network input data and performing a feature extraction in the first network to obtain a multi-dimensional feature graph; and
cutting the multi-dimensional feature graph according to a time sequence, combining feature values with an identical timestamp in different dimensions to generate new feature vectors, arranging the new feature vectors according to the time sequence, and sequentially inputting the new feature vectors to the second network for training.

2. The neural network-based method according to claim 1, wherein
a horizontal axis, a vertical axis and a longitudinal axis of the three-dimensional image data represents a time dimension, a frequency dimension and a feature dimension respectively, and
the step of cutting the three-dimensional image data comprises: cutting off, paralleling the horizontal axis, one-third of the frequency dimension along a direction from a high-frequency to a low-frequency and retaining two-thirds of the frequency dimension, wherein the two-thirds of the frequency dimension is low-frequency three-dimensional image data as the network input data.

3. The neural network-based method according to claim 1, wherein a down-sampling is performed only in a frequency dimension of the three-dimensional image data and a time sequence length of the network input data is kept in a time dimension of the three-dimensional image data, when the feature extraction is performed in the first network.

4. The neural network-based method according to claim 1, wherein the first network comprises a convolutional neural network (CNN), and the second network comprises a recurrent neural network (RNN).

5. A neural network-based device for processing an audio signal time sequence, the device comprising:
a model creating unit configured to create a combined network model comprising a first network and a second network; and
an audio signal optimizing unit configured to: acquire a time-frequency graph of an audio signal, sequentially shift an interception window of the first network to obtain intercepted time-frequency graphs with an identical length, wherein a length of each of the intercepted time-frequency graphs is identical as a time window length of the second network; and optimize the intercepted time-frequency graphs to obtain optimized time-frequency graphs, combine the optimized time-frequency graphs, a first-order difference image of the optimized time-frequency graphs and a second-order difference image of the optimized time-frequency graphs into a piece of three-dimensional image data, and cut the three-dimensional image data to obtain network input data, wherein
the model creating unit is further configured to: train the first network by using the network input data and perform a feature extraction in the first network to obtain a multi-dimensional feature graph; and cut the multi-dimensional feature graph according to a time sequence, combine feature values with an identical timestamp in different dimensions to generate new feature vectors, arrange the new feature vectors according to the time sequence, and sequentially input the new feature vectors to the second network for training.

6. A neural network-based system for processing an audio signal time sequence, comprising:
at least one memory configured to store one or more program instructions; and
at least one processor configured to execute the one or more program instructions to perform the neural network-based method according to claim 1.

7. A computer-readable storage medium, comprising one or more program instructions, wherein a neural network-based system for processing an audio signal time sequence executes the one or more program instructions to perform the neural network-based method according to claim 1.

8. The neural network-based system according to claim 6, wherein
a horizontal axis, a vertical axis and a longitudinal axis of the three-dimensional image data represents a time dimension, a frequency dimension and a feature dimension respectively, and
the step of cutting the three-dimensional image data comprises: cutting off, paralleling the horizontal axis, one-third of the frequency dimension along a direction from a high-frequency to a low-frequency and retaining two-thirds of the frequency dimension, wherein the two-thirds of the frequency dimension is low-frequency three-dimensional image data as the network input data.

9. The neural network-based system according to claim 6, wherein a down-sampling is performed only in a frequency dimension of the three-dimensional image data and a time sequence length of the network input data is kept in a time dimension of the three-dimensional image data, when the feature extraction is performed in the first network.

10. The neural network-based system according to claim 6, wherein the first network comprises a convolutional neural network (CNN), and the second network comprises a recurrent neural network (RNN).

11. The computer-readable storage medium according to claim 7, wherein
a horizontal axis, a vertical axis and a longitudinal axis of the three-dimensional image data represents a time dimension, a frequency dimension and a feature dimension respectively, and
the step of cutting the three-dimensional image data comprises: cutting off, paralleling the horizontal axis, one-third of the frequency dimension along a direction from a high-frequency to a low-frequency and retaining two-thirds of the frequency dimension, wherein the two-thirds of the frequency dimension is low-frequency three-dimensional image data as the network input data.

12. The computer-readable storage medium according to claim 7, wherein a down-sampling is performed only in a frequency dimension of the three-dimensional image data and a time sequence length of the network input data is kept in a time dimension of the three-dimensional image data, when the feature extraction is performed in the first network.

13. The computer-readable storage medium according to claim 7, wherein the first network comprises a convolutional neural network (CNN), and the second network comprises a recurrent neural network (RNN).
